(19) United States
(12) Patent Application Publication
(10) Pub. No.: US 2006/0195913 A1
(43) Pub. Date: Aug. 31, 2006

(54) Method for remote registration of property rights over media items

(76) Inventors: Mikhail Popov, Troitsk (RU); Vladimir Butenko, Zheleznodorozhny (RU)

Correspondence Address: BROMBERG & SUNSTEIN LLP, 125 SUMMER STREET, BOSTON, MA, 02110-1618, US

(21) Appl. No.: 11/351,291

(22) Filed: Feb. 9, 2006

Related U.S. Application Data
(60) Provisional application No. 60/593,731, filed on Feb. 9, 2005.

(51) Int. Cl. H04L 9/32

(52) U.S. Cl. 726/28

(57) ABSTRACT

A method for the remote registration of a person's property rights over copyrighted media items: A remote registration of property rights over copyrighted media items is conducted by comparing the characteristic attributes of the person's items with the characteristic attributes of the items stored in the item database, by a system of a processing center, a means for the remote claiming of property, and a remote proof of ownership of media items. The remote registration is conducted on the person's property items, based on which the property rights over these items are acknowledged and benefits entitled to these property rights are granted to the owner. These benefits include, notably a transfer of a free digital copy of the media item protected by digital rights management (DRM) to the owner. The method enables a legal, fast and efficient transition of the media item ownership model from physical copy-based to digital copy-based, while recognizing each person's private property acquired to date and preventing harmful effects of mass digital copying, such as, proliferation of piracy. The method further enables a creation or an updating of a person's profile of preferences to facilitate further recommendations and sales of media items to the person.

### PRIORITY

This patent application claims priority from provisional U.S. patent application No. 60/593,731, filed Feb. 9, 2005, entitled, “Method for Remote Registration of Property Rights Over Media Items,” and naming Mikhail Popov and Vladimir Butenko as inventors, the disclosure of which is incorporated herein, in its entirety, by reference.

### BACKGROUND OF THE INVENTION

Today, a person possesses multiple items of property. A large part of this property is protected by copyright. Such copyrighted property includes music stored in the form of compact disks, LPs, or tapes, books printed on paper, movies and videos stored on DVDs or videotapes, photos stored on paper, paintings or other images, stored as originals, postcards or posters, videogames, and others. Thus, there is a lot of sources of information, but there is a probability that one has time to deal with only some of them at a time. And each type of device demands its own reproducing technical systems.

With the advent of digital media-server technology, high-capacity digital random access storage devices, such as hard disk drives, flash memories are becoming the main storage devices. Year after year, the memory capacity of these devices has been increasing, while the price for them has been falling. In average, the capacity of hard disk drives increases by more than two times a year.

In future, the storage of all media items on one high-capacity random access storage device will be mass. For example, one TV server is capable of storing all media items of a person (about 1000 CDs, 650 DVDS, 200 personal video (1 hour long)).

The advantage of such storage is that a person stores all information on one device, which makes it (information) more accessible. A possibility to add new information in digital format appears. Thus, the collection will be constantly growing and it will be convenient for use. Besides, this will allow avoiding distortions, interferences and noises inevitable in the case of storing information on records, discs and so forth. Moreover, the already existing distortions and noises can be easily corrected.

Another important fact in favour of such storage: a change of digital format will not involve much time or high financial expenses for its transformation into another format. This may be of use, where, one format will substitute for another, as it has already happened before. For example, WAV was followed by MP3 that is not of worse quality but is more compact (it takes less space).

On the other hand, a person spends a very big part of his time outside his home. If he is going somewhere, he cannot take his tape recorder, video recorder, LP-player, photos and so forth, as well as numerous cassettes, records and so forth with him. But now, this problem can be solved. If to have the whole musical collection with you were inconceivable earlier, it will be commonplace soon.

Already, today, online sales are a significant part of all sales of media items. But people have accumulated many media items on various devices: in material form (books, photos, pictures and so forth), in digital form (CDs, DVDs). To be able to store all on one device in the future, it is necessary that the already existing media items should be transferred on this device. The question arises: how to do it?

Re-purchasing music from digital sources, such as Apple iTunes or Rhapsody is unlikely to occur for the majority of users. This phenomenon is very different from the replacement of LPs with CDs, which occurred in the 90s and accounted for a majority of the music industry revenues. CDs have a superior value proposition than LPs, notably higher sound quality or longer lifetime. By contrast, hard drive storage offers no improvement of these important parameters. Therefore, the user is unlikely to repay the full price of his or her collection, which can be a considerable sum of money. For instance, a typical CD collection of a mass-market user interested in music is about 200-300 CDs, while a CD collection of a audiophile can be 1000 CDs or larger. With the average CD retail price of about $15, the first can add to several thousand dollars and the second to $15000. Adding other copyrighted items, the numbers become very significant.

At the same time, a person's musical collection often has high emotional value; therefore, he will want to have his music converted to the hard drive. Then, he gets an opportunity to make his own play lists for the gym, driving and studying, and create his own ‘best of albums’ of his favorite artists almost without spending any time for it.

Existing solutions proposed, in particular, by the vendors of digital audio servers (Audio ReQuest, . . . ) or portable MP3 players (Apple's iPod, . . . ), consist of having users conduct the transfer themselves using their PCs or other computers. This operation can take a very significant amount of time. In the above example of 200-300 CDs, assuming 15′ per CD, the total operation could take up to 75 hours.

Overall, there are about 10 billion CDs in the US waiting to be transferred.

As far as vinyl recordings are concerned, their transformation into a digital format could take from one to four (several) hours. The reason is that, one has to convert the analogue signal into a digital one and afterwards, in order to get perfect sound, to get rid of noises appearing after the conversion.

Additionally, this self-transfer result in digital files stored on a computer without any rights management protection. That is, a user can easily distribute the digital file illegally to other people, or upload the file to file-sharing networks like Kazaa or Morpheus. Thus, the self-transfer operation will open ways to a potentially illegal action and will cause overall damage to the overall economics of the music industry.

The problem of using somebody else's media items is already topical today. In due course it will scale up. Probably, to solve this problem, we will have to check the legality of people's use of media items. Today, the rights management protection is one of the key tasks. But the question, what to do with those media items, which were bought earlier, and are not protected, remains unsolved.

Thus, the firm RipDigital (www.ripdigital.com) offers the owner to transfer their CD-collection to DVDs and, if desired, to a portable hard disk (DVD record is an interim stage). As a result, all CD Collections will be stored on one device). In order to use the service, the owner sends his CD collection in a physical form to the recording studio. There, each CD is copied. Ripbigital does not make a reserve copy of a CD and every time makes a copy again—in order to protect rights of performers. The time of execution of the work depends on the volume of collection. They convert 200 CDs for 5 business days, and 1000 CDs—for 7 business days, excluding the time for delivery and dispatch. Thus, the overall period for conversion of even a small collection is about 10 days, of a big one—2 weeks. This is quite a long period. Afterwards, the owner can copy mp3 files from DVD to his computer. RipDigital tags every file with the name of the owner. And if a person decides to upload the file to file-sharing networks like Kazaa or Morpheus, the Recording Industry Association of America can see to it.

This invention allows providing the service without delivery of the discs to a firm's office in physical form. Despite the fact that the collection to be sent is insured, the loss of it during transit, can't be compared with the compensation to be given under the insurance. Many discs can be of great importance to the owner.

This invention allows to reduce the time for providing the service and to reduce the cost of it: on account of an absence of physical delivery (without spending time and money on transportation and insurance) and on account of the fact that there is no necessity in copying each disc—the files are downloaded from the database, which greatly saves time and can be done without the participation of a person.

The collection is returned in an organised manner convenient for use and adding new files, and it has protection from unauthorised use.

The service of recognition and conversion (music, films, . . . ) can be provided by, for example,:
Music Majors: Universal Music Group (UMG), Sony Music Entertainment, BMG, EMI, Warner Music Group and their labels, etc.
Internet service providers: AOL, Comcast, Cox, etc.
Entertainment (computer) hardware vendors: Apple, Sony, Philips, Dell, IBM, RIM, etc.
Software vendors: Microsoft, Oracle, etc.
Electronics retail stores: Best Buy, Circuit City, Good Guys, Virgin, etc.
Specialized companies: Gracenote, Listen.com, Netflix, etc.
Telecommunications operators: AT&T, MCI, Sprint, Verizon, etc.
Internet portals: Yahoo!, Amazon, eBay, etc.

Some firms (ISP), for example, Comcast, provide the service of personal digital radio (Comcast Rhapsody), including access, for example, via Internet, to the database of musical files, possibility to search for your favourite music, listen to complete albums, create custom play lists and radio stations, access to music from any Windows PC. Whereby, a user can burn own CDs (for a separate charge per song). The cost of such a service is about $10/month (equivalent current CD spending).

But, a majority of people already has their own musical collections of tapes, LPs, CDs. And they will hardly like to pay as much as those who do not have their own collections. A question arises: How to do, so that the majority of people would use the service of personal music digital radio? One of the decisions is to give to those, who already have their own collections, discounts proportionate to the volume of such collections. This may be done on the basis of examination of property rights over their personal collection.

A remote examination of property rights is already in use, for example, by Microsoft to update Windows and by producers of anti-virus programs to update these programs via Internet.

### SUMMARY OF THE INVENTION

The essence of the invention is that, an ad hoc processing center, for example, an automatically operating website, provides the service of remote identification of items and determination of property rights over the items with the subsequent grant of some benefits to the owner.

The processing center comprises a base of characteristic attributes of copyrighted media items made up by the processing center or given by other companies. When an owner applies to the processing center for identification and examination of property rights over an item, the processing center reads characteristic attributes of the item and compares the received characteristic attributes with the characteristic attributes of this item available in the base of the processing center. If the characteristic attributes coincide, it is deemed that the owner has property rights over the item. If the characteristic attributes do not coincide, the processing center cannot confirm property rights of the owner over this item.

Since characteristic attributes can be highly reliable determiners of property rights over some categories of items (for example, a slip, cheque, a note in a bank history of a credit card, a password or a cipher and so forth) or less reliable (for example, a photo shot of their appearance, translation of a sound, video shots and so forth), in order to increase the reliability of determination of property rights, it is necessary that additional methods of examination of property rights, such as legally enforceable confirmation by the owner of his rights by way of signing a declaration, for example, by way of a digital signature, should be used.

Upon confirmation of property rights, the processing center offers the owner the use of the certain benefit. The benefit is granted to the owner by the company—producer of the item or, upon agreement with the latter, by the processing center.

Along with the identification and determination of property rights the processing center forms a base with the information about the owner, which includes information that is useful for the producer.

The section, which reads characteristic attributes of an item, includes an operator, a device for a reading of characteristic attributes in the form of images, a sound signal, and system signs.

The owner or an employee of the processing center or their substitute (e.g. computer or robot) can be the operator.

As devices-producing of images, one can use photo cameras, video cameras—separate or fitted into other technical systems, digital or analogue, with the subsequent conversion into a digital signal by proper devices. Images may include: an image of the item, bar code, shots on TV screen, computer or any other reproducing device and so forth.

As devices-producing of a sound signal, one can use microphones from any device, for example, computer, telephone, hard drive of the computer and so forth.

As a device for reading system attributes, one can use any device allowing a reading of system information, which describes operation and content of information accumulators. Such can be, for example, a hard drive of a computer when determining characteristic attributes of, for example, a CD, a DVD.

For identification of an item it is necessary first, to recognize image and sound information with the help of a program for recognition, and then to form an inquiry to the operator in order to confirm and/or to correct the name of the item or its part.

After the correctness of the identification of the item or its part has been confirmed, it is possible to examine property rights with the help of a program for comparison. The program includes the modules: applying to the base of characteristic attributes, receiving and processing characteristic attributes from the section for reading information, comparing of characteristic attributes and issue of results of comparison.

As a benefit, the processing center can offer: a credit, discounts, digital copies of media items (music, films, TV show, books, theatre performances and so forth) and others.

### BRIEF DESCRIPTION OF THE DRAWING

The foregoing and other objects, features, and advantages of the invention will be apparent from the following more particular description of preferred embodiments of the invention, as illustrated in the accompanying drawings in which like reference characters refer to the same parts throughout the different views. The drawings are not necessarily to scale, emphasis, instead, being placed upon illustrating the principles of the invention.

FIG. 1 is a general schenme of interrelations between the processing center for remote identification and examination of property rights and the owner.

FIG. 2 illustrates various embodiments of the processing center;

FIG. 3 is a section for the reading of characteristic attributes of an item;

FIG. 4 shows the content of the section for comparison;

FIG. 5 illustrates the types of benefits the processing center can grant to the owner;

FIG. 6 illustrates the organisation of the process of remote identification and examination of property rights over media items.

### DETAILED DESCRIPTION OF THE INVENTION

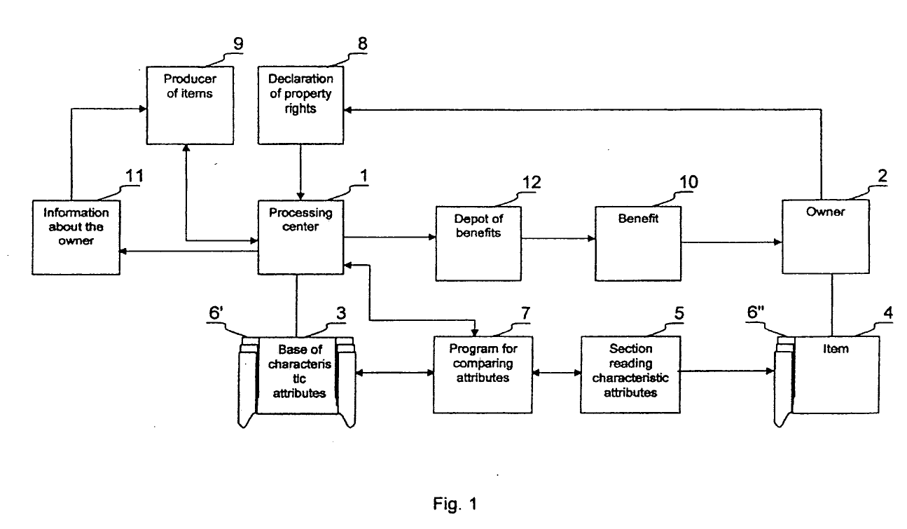

FIG. 1 illustrates a general scheme of interrelations between the processing center 1 for remote identification and the owner 2.

The processing center 1 has a base of characteristic attributes of media items 3 made by the processing center itself or given by other companies. When applying the owner 2 to the processing center 1 for providing identification and examination of property rights over an item 4, the processing center reads characteristic attributes 6″ of the item 4 with the help of the section 5 and compares the received characteristic attributes 6″ with the characteristic attributes of the item 6′ available in the base of the characteristic attributes 3 with the help of the section for comparison 7. If the characteristic attributes 6′ and 6″ coincide, it is deemed that the owner has property rights over this item. If the characteristic attributes 6′ and 6″ do not coincide, the processing center cannot confirm property rights of the owner over the item.

Since characteristic attributes can be highly reliable determiners of property rights over some categories of items (for example, a slip, a cheque, a note in a bank history of a credit card, a password or a cipher and so forth) or less reliable (for example, a photo-shot of an appearance, a sound signal or a sequence of video-shots), in order to increase reliability of determination of property rights, it is necessary that additional methods of examination of property rights, such as legally enforceable confirmation by the owner 2 of these rights by way of signing a declaration 8 should be used. In the declaration 8, the owner confirms that he or the members of his household or a legal entity, of which he is a representative, have, in reality, property rights over the given item.

Upon some reliable confirmation of property rights that is established by the processing center 1 separately for each category of items (under agreement with companies—producers 9 of these items, as well as with copyright owners) the processing center 1 offers the owner the use of a certain benefit 10. The benefit 10 is granted to the owner 2 by the company—producer 9 of the item 4 or, upon agreement with the latter, by the processing center 1 from its own depot of benefits 12.

Along with the identification and determination of property rights the processing center 1 forms a base with the information 11 about the owner 2, which includes the information useful for the producer 9. Upon an agreement with the owner, the processing center 1 gives information 11 to the producer 9.

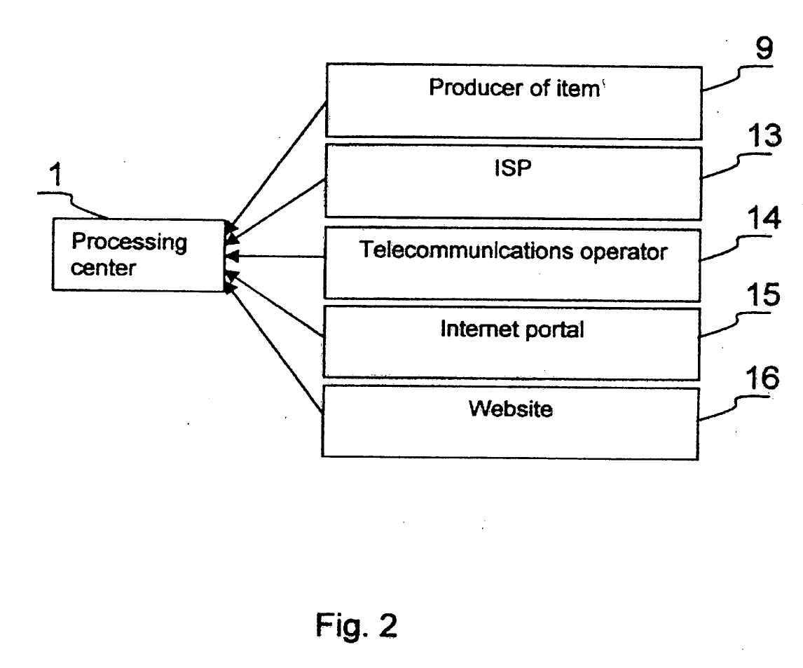

FIG. 2 illustrates various embodiments of the processing center 1. Such can be a company-producer 9 of the item 4, 13—ISP, 14—telecommunications operator, 15—internet-portal, 16—website.

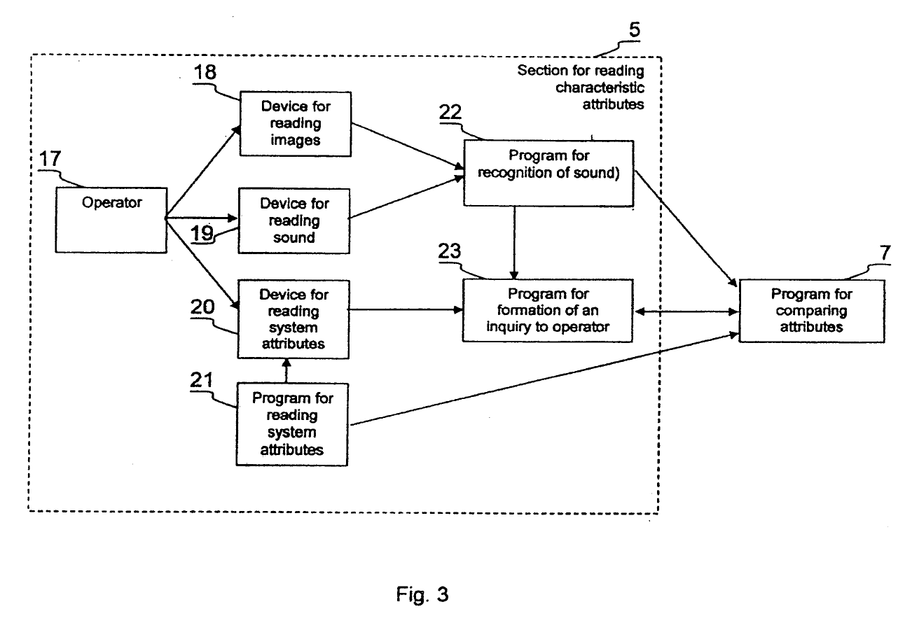

FIG. 3 illustrates the section 5, which reads characteristic attributes of an item 4. It can include an operator (or its substitute, e.g. computer, robot) 17, a device reading characteristic attributes in the form of images 18, a sound signal 19, system attributes 20.

The owner 2, an employee of the processing center or his substitute (e.g. computer, robot) can be an operator 17.

As devices 18 one can use photo cameras, video cameras—separate or fitted into other technical systems, digital or analogue with the subsequent conversion into a digital signal by proper devices. Images may include: an image of the item, bar code, shots on TV screen, computer or any other reproducing—devices and so forth.

As a device 19 one can use microphones of any device (for example, computer, telephone), a disc drive of the computer and so forth.

As a device 20 one can use any device allowing reading of system information, which describes operation and content of information accumulators. Such can be, for example, the disc drive of a computer when determining characteristic attributes of, for example, a CD, a DVD. Under the control of the program 21, such system attributes as: attributes in system parts of file system (in catalogues, in tables of sections, in downloading notes, in tables of file storage), attributes in files (in program files, in data files, in files of program settings, in files of documents), attributes in clusters (in ‘free’ clusters, in ‘lost’ clusters, etc.) can be read.

For identification of an item it is necessary first, to recognise image and sound information with the help of a program for recognition 22, and then, with the help of the program 23 to form an inquiry to the operator in order to confirm and/or to correct the name of the item or its part.

After the correctness of the identification of the item or its part has been confirmed, it is possible to examine property rights with the help of the program for comparison 7.

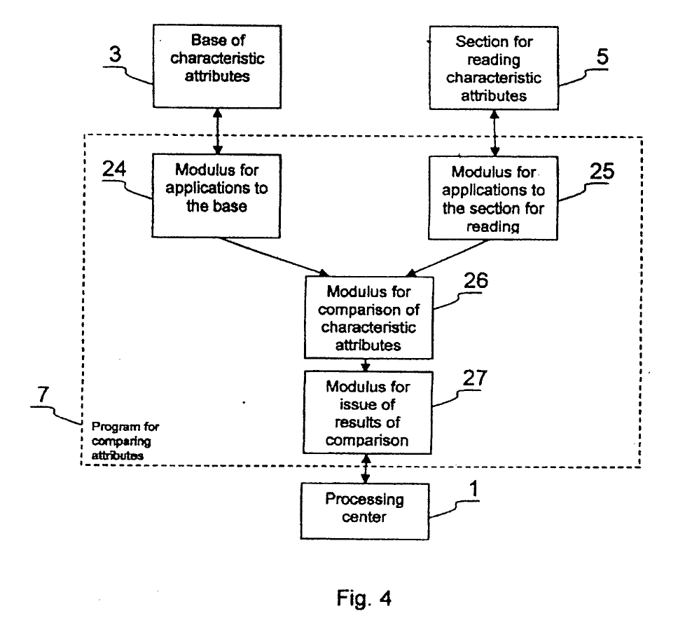

FIG. 4 illustrates the elements of the program of the section for comparison 7.

The program includes the module: 24—applying to the base of characteristic attributes 3, 25—applying to the section for reading of characteristic attributes, 26—comparing characteristic attributes and 27—issue of results of comparison.

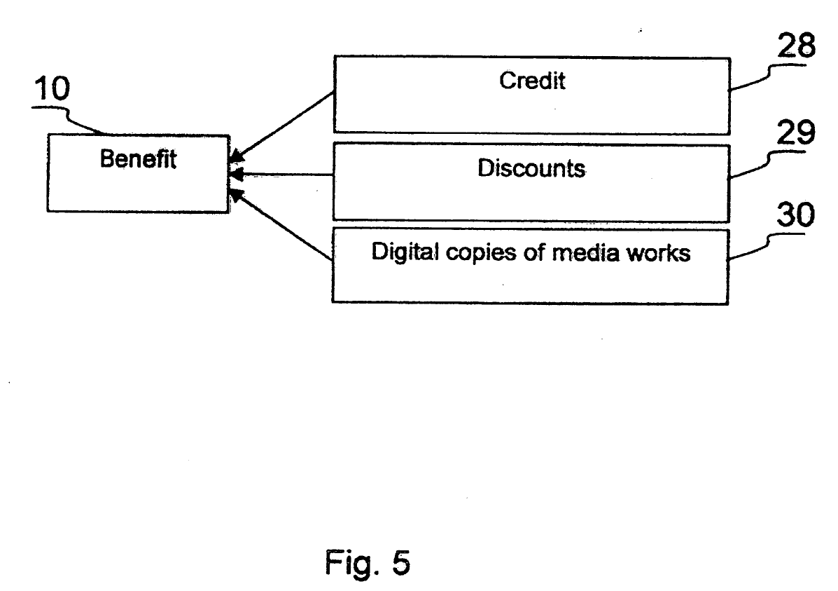

FIG. 5 illustrates types of benefits 10, granted by the processing center 1 to the owner 2. As a benefit, the center can propose: 28—a credit, 29—discounts, 30—digital copies of media items (music, films, TV show, books, theatre performances and so forth) and other benefits.

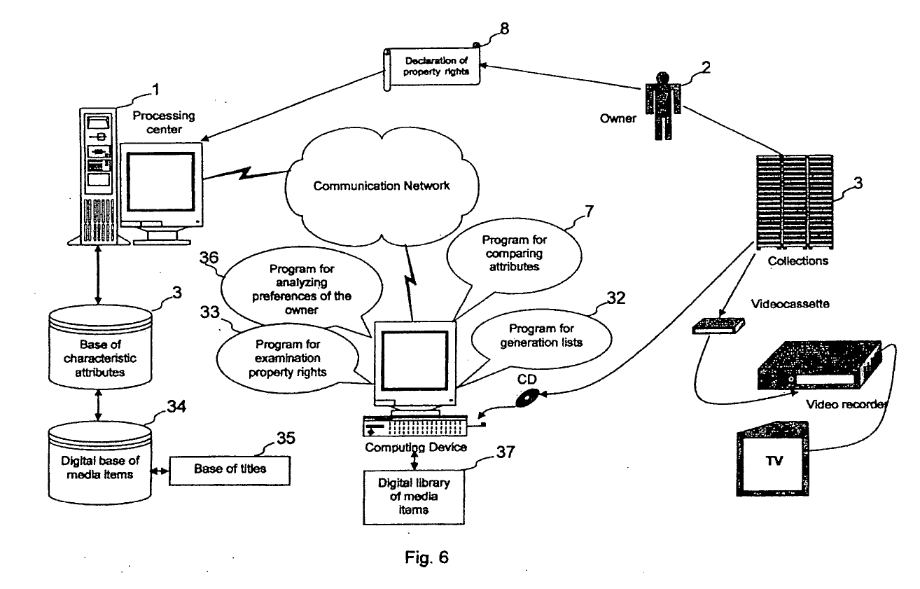

FIG. 6 shows the organisation of the process of remote identification and examination of property rights over a media item with, in case of positive results of the examination, granting of benefits in the form of digital copies of media items to the owner, and the organisation of them into a digital library convenient for use.

The owner 2 has collections of media works (music on CD, DVD, films on tapes, sound books or books stored on paper and so forth) 31, and would like to convert them into a digital media library convenient for use. For these purposes he applies to the processing center 1. The processing center 1 explains the owner 2, that, all media—items are protected by copyright law; and transfer of the copies to the owner is not possible unless the latter has property rights over the item. The examination of property rights consists of 3 stages: 1) the owner 2 signs a declaration of property rights 8, 2) the owner 2 and the processing center 1 make a list of the items for each collection, 3) the processing center provides a selective or a full examination of media items.

The Second and third stages can be combined because the list of media items can be automatically generated during the process of proving ownership.

The list is created during the process of proving ownership by way of the program for generation lists 32 on the basis of results of comparison (identification) of characteristic attributes by the section 7. It would demand, for example, playing all discs and tapes. The timing for playing depends on speed of determination of characteristic attributes (several seconds).

Except for this method, there is a possibility to make a list by way of owner's choice (or an employee's of the processing center made at the owner's home) of titles of works from a base of titles of works 35 that is created on the basis of libraries of media items 34 available in the library. In the process of creation of the list, a special program 36 analyses preferences of the owner, predicts provisional content of the owner's collection, writes down the titles or artists' names instead of the owner and/or forms a reduced variant of the base of titles, whereby simplifying search for items and formation of the list.

The owner may be examined, wholly or selectively, by the processing center at the owner's place, or by an employee of the processing center or remotely, via telecommunications channels. A remote selective or whole examination consists of consecutive execution by the owner 2 of instructions made by the program for examination 33.

The program for examination includes the modules: generation of a short list of items subjected to examination from each collection (for example, 3 out of each 100), determination of the method of examination (choice of one or a combination of characteristic attributes of the work), and generation of step-by-step instructions of operator's actions (the owner or an employee). Upon positive results of the examination of property rights, the processing center transfers the digital copies from libraries (bases) of media items 34 available in the processing center to the digital library 37 of the owner 2. The transfer is made by way of a note on portable hard disk and its delivery to the owner by post, by a courier and so forth, or via the network.

The digital media library is formed by the processing center 1 in a standard way or with regard to preferences of the owner.

### SCOPE OF DISCLOSURE

The preferred embodiment of this invention is described above in figures and detailed description. Unless specifically noted, it is the intention of the inventors that the words and phrases in the specification and claims be given the ordinary and accustomed meanings to those of ordinary skill in the applicable art(s). The foregoing description of a preferred embodiment and best mode of the invention known to the applicant at the time of filing the application has been presented for the purposes of illustration and description. It is not intended to be exhaustive or to limit the invention to the precise form disclosed, and many modifications and variations are possible in the light of the above teaching. The embodiment was chosen and described in order to best explain the principles of the invention and its practical application, and to enable others, skilled in the art, to best utilize the invention in various embodiments and with various modifications as are suited to the particular use contemplated.

In this patent, the owner is a person or a household or legal entity.

Copyrighted media items are one of:
music and other sounds
books
postcards or posters, and other printed matter
movies and videos
photos
paintings or other images

Up-selling is deemed to be sales of “sequels” or, new editions. For example, there is a film “Harry Potter” and there is its continuation “Harry Potter 2”. Similarly, some books have several editions.

Physical carrier is a physical CD, DVD or cover art, book printed on paper, or other carrier.

Common context origin is to be deemed discs of the same performer, books of the same author, of the same series, of the same publisher's and other.

The inventive ideas described in this disclosure can be extended and generalized to other cases of property registration, such as registration of home appliances, consumer electronic devices, computers, etc.

### REFERENCES CITED

6609105 August, 2003 U.S. Patent Document

Ove Granstrand, “The Shift Towards Intellectual Capitalism—the Role of Infocom Technologies” (1999).

W. Wayt Gibbs, “Plug-and-Play Robots: Personal robots may soon be as cheap and customizable as personal computers”; Scientific American, April 2004, 3 page(s).

Ernest Fritz Hollings, “Security Systems, Standards and Certification Act (SSSCA)” 107^{th} CONGRESS 2^{nd} Session.

Damien Cave, “Chained Melodies”, Salon, Mar. 25, 2002.

Optical Storage Technology Association, Compact Disc-Recordable & CD- Re-Writable Questions & Answers, OSTA-4, Revision 2.00, 15 Jul. 1997.

Kurzweil et al. 1999; Computer World.

Leijonhufvud, A. 1989: Information costs and the division of labor. International Social Science Journal, 120, 165-176.

A. Odlyzko (AT&T Research), R. R. John in “Spreading the News: The American Postal System from Franklin to Morse” Harvard U. Press 95.

What is claimed is:

1. A method for conducting remote registration of an owner's property rights over copyrighted media items comprising:
a processing center;
a means for remote claiming of copyrighted media items;
a remote proof of ownership of copyrighted media items.

2. The method of claim 1, wherein said processing center is one of internet service provider, telecommunications operator, internet portal, website, hardware or software manufacturer.

3. The method of claim 1, wherein said copyrighted media items are not transferred to the processing center.

4. The method of claim 1, wherein said means for the remote claiming of copyrighted media items is the owner entering identifiers of copyrighted media items on the website.

5. The method of claim 1, wherein said means for the remote claiming of copyrighted media items is the owner taking an image of a bar code of physical carriers of copyrighted media items and forwarding it to the processing center.

6. The method of claim 1, wherein said the remote proof of ownership of copyrighted media property is conducted for all of the owner's copyrighted media items or selectively among these items.

7. The method of claim 1, wherein said remote proof of ownership of copyrighted media items consists in comparing of characteristic attributes of items stored at the processing center with characteristic attributes of items received from identification of the owner's copyrighted media items.

8. The method of claim 7, wherein said comparing characteristic attributes of items is made at the owner's location.

9. The method of claim 7, wherein said comparing characteristic attributes of items is made at the processing center.

10. The method of claim 7, wherein said comparing characteristic attributes of items is made using a computer program.

11. The method of claim 7, wherein said comparing characteristic attributes of items is made by inserting disks into a disk drive.

12. The method of claim 1, wherein said remote proof of the ownership of copyrighted media items consists in one separate method or a combination of several methods.

13. The method of claim 1, wherein the owner applies his signature to ensure legal relevance of said registration.

14. The method of claim 1, wherein said remote registration of an owner's property rights over copyrighted media items is conducted by analyzing of a digital image of the copyrighted media items.

15. The method of claim 14, wherein said digital image is made by using a scanner, a digital still image camera, a digital video camera, a camera phone, or any other digital image.

16. The method of claim 14, wherein said digital image is taken by the owner and transferred to the processing center.

17. The method of claim 14, wherein said analysis of digital images is conducted separately for each item or for a substantial part of items simultaneously.

18. The method of claim 1, wherein said remote proof of the ownership of copyrighted media items can be simultaneously used as said means for the remote claiming of copyrighted media items.

19. A computer program, comprising the functions of:
Accessing a database with information about items;
Receiving information about owner-copyrighted media items;
Comparing characteristic attributes of items stored in the database with characteristic attributes of items received from identification of the owner's copyrighted media items;
Providing a result of comparison.

20. A method for conducting remote registration of an owner's property rights over copyrighted media items, wherein the improvement comprises the steps of:
Involving a processing center;
Involving a means for remote claiming of copyrighted media items;
a remote proof of ownership of copyrighted media items.
